(19) United States
(12) Patent Application Publication
(10) Pub. No.: US 2009/0212138 A1
(43) Pub. Date: Aug. 27, 2009

(54) Center concentrated water stream

(76) Inventors: Kiyoshi Okamoto, San Francisco, CA (US); Ilona Zemelman, San Francisco, CA (US)

Correspondence Address: Kiyoshi Okamoto, 400 Spear St. #217, San Francisco, CA, 94105, US

(21) Appl. No.: 12/070,731

(22) Filed: Feb. 21, 2008

(51) Int. Cl. B05B 1/00

(52) U.S. Cl. 239/589

(57) ABSTRACT

A face plate that is angles to make a dome shape for center concentrated water stream.

### FIELD OF INVENTION

Center concentrated water stream.

### BACKGROUND OF THE INVENTION

It is important for salons to wash out chemicals, perms and color. Therefore it is much more efficient to have a center concentrated water stream to wash out the chemicals. And by center concentrate water stream gives a no splash effect to the client.

### BRIEF DESCRIPTION OF THE DRAWINGS

FIG. 1: Side view of the face plate showing a dome shaped due to it being angled.

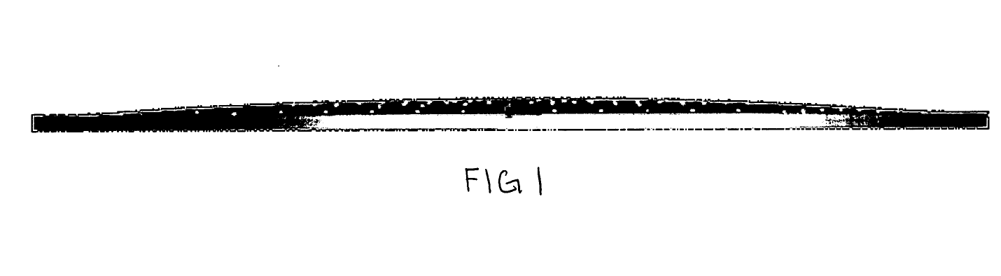

FIG. 2: Front view of the face plate.

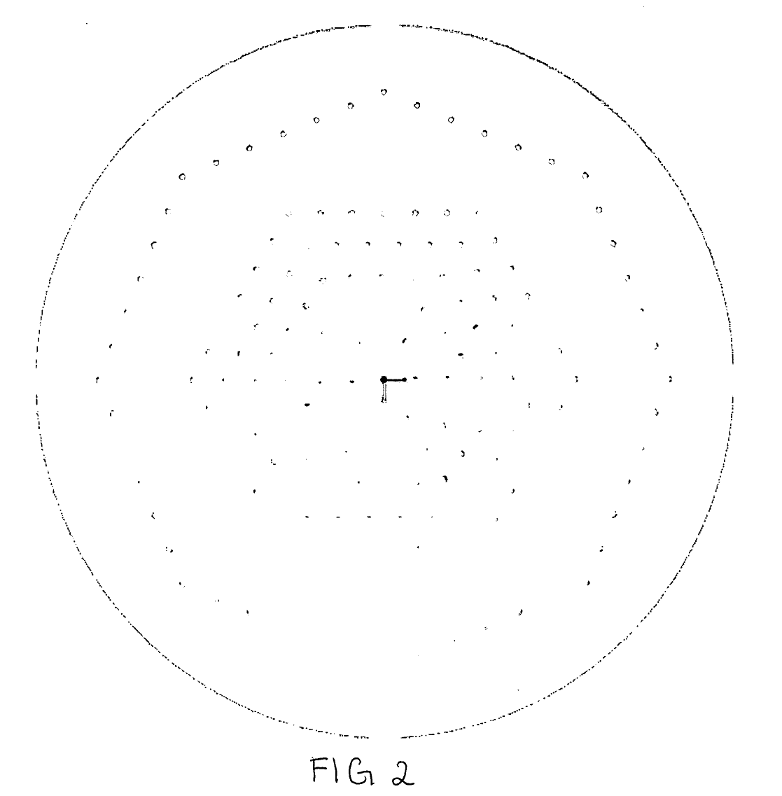

1. The face plate is angled to make the water stream center concentrated.

2. The face plate is a dome shaped.
